(19) United States
(12) Patent Application Publication
(10) Pub. No.: US 2025/0048195 A1
(43) Pub. Date: Feb. 6, 2025

(54) Radio Network Node, User Equipment and Methods Performed Therein

(71) Applicant: Telefonaktiebolaget LM Ericsson (publ), Stockholm (SE)

(72) Inventors: Pradeepa Ramachandra, Linköping (SE); Antonino Orsino, Kirkkonummi (FI); Marco Belleschi, Solna (SE)

(21) Appl. No.: 18/697,152

(22) PCT Filed: Sep. 19, 2022
(86) PCT No.: PCT/SE2022/050820

§ 371 Date: Mar. 29, 2024

Related U.S. Application Data
(60) Provisional application No. 63/250,279, filed on Sep. 30, 2021.

(51) Int. Cl. H04W 36/00; H04W 74/0833

(52) U.S. Cl. CPC H04W 36/0058; H04W 36/0079; H04W 74/0833

(57) ABSTRACT

The embodiments herein relate to, for example, a method performed by a UE (10) for handling communication in a wireless communication network. The UE (10) transmits a SHR to a radio network node (12), wherein the SHR comprises an indicator indicating whether or not the UE has experienced an LBT failure and/or a random access problem5before successfully accessing a target cell in a HO procedure.

### TECHNICAL FIELD

Embodiments herein relate to a radio network node, a user equipment (UE) and methods performed therein regarding wireless communication. Furthermore, a computer program and a computer readable storage medium are also provided herein. In particular, embodiments herein relate to handling communication, such as handling handover (HO) of the UE, in a wireless communications network.

### BACKGROUND

In a typical wireless communications network, UEs, also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node e.g. a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate e.g. enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and coming 3GPP releases, such as New Radio (NR), are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies such as new radio (NR), the use of very many transmit- and receive-antenna elements may be of great interest as it makes it possible to utilize beamforming, such as transmit-side and receive-side beamforming. Transmit-side beamforming means that the transmitter can amplify transmitted signals in a selected direction or directions, while suppressing transmitted signals in other directions. Similarly, on the receive-side, a receiver can amplify signals from a selected direction or directions, while suppressing unwanted signals from other directions.

A Self-Organizing Network (SON) is an automation technology designed to make the planning, configuration, management, optimization and healing of mobile radio access networks simpler and faster. SON functionality and behavior has been defined and specified in generally accepted mobile industry recommendations produced by organizations such as 3rd Generation Partnership Project (3GPP) and the Next Generation Mobile Networks (NGMN).

In 3GPP, the processes within the SON area are classified into Self-configuration process and Self-optimization process. Self-configuration process is the process where newly deployed nodes are configured by automatic installation procedures to get the necessary basic configuration for system operation.

This process works in pre-operational state. Pre-operational state is understood as the state from when an eNB is powered up and has backbone connectivity until a Radio Frequency (RF) transmitter is switched on.

As illustrated in FIG. 1, functions such as Basic Setup and Initial Radio Configuration, handled in the pre-operational state are covered by the Self Configuration process.

Self-optimization process is defined as a process where UE and access node measurements and performance measurements are used to auto-tune a network.

This process works in operational state. Operational state is understood as a state where the RF interface is additionally switched on.

As described in FIG. 1, functions handled in the operational state, like Optimization/Adaptation, are covered by the Self Optimization process.

FIG. 1 shows ramifications of Self-Configuration/Self-Optimization functionality, from 3GPP TS 36.300 v. 16.0.0 figure 22.1-1.

In LTE, support for Self-Configuration and Self-Optimization is specified, as described in 3GPP TS 36.300 v. 16.0.0 section 22.2, including features such as Dynamic configuration, Automatic Neighbour Relation (ANR), Mobility load balancing, Mobility Robustness Optimization (MRO), random access channel (RACH) optimization and support for energy saving.

In NR, support for Self-Configuration and Self-Optimization is specified as well, starting with Self-Configuration features such as Dynamic configuration, ANR in Rel-15, as described in 3GPP TS 38.300 v. 15.0.0 section 15. In NR Rel-16, more SON features are being specified for, including Self-Optimization features such as MRO.

MRO in 3GPP, seamless handovers (HO) are key features of 3GPP technologies. Successful handovers ensure that the UE moves around in the coverage area of different cells without causing too many interruptions in the data transmission. However, there will be scenarios when the network node fails to handover the UE to the ‘correct’ neighbor cell in time and in such scenarios the UE will declare the radio link failure (RLF) or Handover Failure (HOF).

Upon HOF and RLF, the UE may take autonomous actions, i.e. trying to select a cell and initiate reestablishment procedure so that it is ensured that the UE is trying to get back as soon as it can, so that it can be reachable again. The RLF will cause a poor user experience as the RLF is declared by the UE only when it realizes that there is no reliable communication channel (radio link) available between itself and the network. Also, reestablishing the connection requires signaling with the newly selected cell, for example, requiring random access procedure, radio resource control (RRC) Reestablishment Request, RRC Reestablishment RRC Reestablishment Complete, RRC Reconfiguration and RRC Reconfiguration Complete, and adds some latency until the UE can exchange data with the network again.

According to the specifications (3GPP TS 36.331 v. 16.0.0), the possible causes for the radio link failure could be one of the following:
1) Expiry of the radio link monitoring related timer T310;
2) Expiry of the measurement reporting associated timer T312, not receiving the handover command from the network within this timer's duration despite sending the measurement report when T310 was running;
3) Upon reaching the maximum number of radio link control (RLC) retransmissions;
4) Upon receiving random access problem indication from the medium access control (MAC) entity.

As RLF leads to reestablishment of a connection which degrades performance and user experience, it is in the interest of the network to understand the reasons for RLF and try to optimize mobility related parameters, e.g., trigger conditions of measurement reports, to avoid later RLFs. Before the standardization of MRO related report handling in the network, only the UE was aware of some information associated to how did the radio quality looked like at the time of RLF, what is the actual reason for declaring RLF, etc. For the network to identify the reason for the RLF, the network needs more information, both from the UE and from the neighboring base stations.

As part of the MRO solution in LTE, the RLF reporting procedure was introduced in the RRC specification in Rel-9 RAN2 work. That has impacted the RRC specifications, TS 36.331 v. 16.0.0, in the sense that it was standardized that the UE would log relevant information at the moment of an RLF and later report to a target cell the UE succeeds to connect, e.g. after reestablishment. That has also impacted the inter-gNodeB interface, i.e., X2AP specifications, 3GPP TS 36.423 v. 16.0.0, as an eNodeB receiving an RLF report could forward to the eNodeB where the failure has been originated.

For the RLF report generated by the UE, its contents have been enhanced with more details in the subsequent releases. The measurements included in the measurement report based on the latest LTE RRC specification are:
1) Measurement quantities, reference signal received power (RSRP), reference signal received quality (RSRQ), of the last serving cell such as a primary cell (PCell).
2) Measurement quantities of the neighbor cells in different frequencies of different RATs, E-UTRA, UTRA, GSM EDGE Radio Access Network (GERAN), Code Division Multiple Access 2000 (CDMA2000.
3) Measurement quantity, such as Received Signal Strength Indicator (RSSI), associated to wireless local area network (WLAN) access points.
4) Measurement quantity, such as RSSI, associated to Bluetooth beacons.
5) Location information, if available, including location coordinates and velocity.
6) Globally unique identity of the last serving cell, if available, otherwise the physical cell identifier (PCI) and the carrier frequency of the last serving cell.
7) Tracking area code of the PCell.
8) Time elapsed since the last reception of the ‘Handover command’ message.
9) Cell Radio Network Temporary Identifier (C-RNTI) used in the previous serving cell.
10) Whether or not the UE was configured with a data radio bearer (DRB) having a Quality-of-Service Class Indicator (QCI) value of 1.

After the RLF is declared, the RLF report is logged and included in the VarRLF-Report and, once the UE selects a cell and succeeds with a reestablishment, it includes an indication that it has an RLF report available in the RRC Reestablishment Complete message, to make the target cell aware of that availability. Then, upon receiving an UEInformationRequest message with a flag “rlf-ReportReq-r9” the UE shall include the RLF report, stored in a UE variable VarRLF-Report, as described above, in an UEInformationResponse message and send to the network.

Based on the RLF report from the UE and the knowledge about which cell did the UE reestablished itself, the original source cell may deduce whether the RLF was caused due to a coverage hole or due to handover associated parameter configurations. If the RLF was deemed to be due to handover associated parameter configurations, the original serving cell can further classify the handover related failure as too-early, too-late, or handover to wrong cell classes. These handover failure classes are explained in brief below.
1) Whether the handover failure occurred due to the “too-late handover” cases
   a. The original serving cell can classify a handover failure to be “too late handover” when the original serving cell fails to send the handover command to the UE associated to a handover towards a particular target cell, and if the UE reestablishes itself in this target cell post RLF.
   b. An example corrective action from the original serving cell could be to initiate the handover procedure towards this target cell a bit earlier by decreasing the cell individual offset (CIO) towards the target cell that controls when the UE sends the event triggered measurement report that leads to taking the handover decision.
2) Whether the handover failure occurred due to the “too-early handover” cases
   a. The original serving cell can classify a handover failure to be “too early handover” when the original serving cell is successful in sending the handover command to the UE associated to a handover, however the UE fails to perform the random access towards this target cell.
   b. An example corrective action from the original serving cell could be to initiate the handover procedure towards this target cell a bit later, by increasing the CIO towards the target cell that controls when the UE sends the event triggered measurement report that leads to taking the handover decision.
3) Whether the handover failure occurred due to the “handover-to-wrong-cell” cases
   a. The original serving cell can classify a handover failure to be “handover-to-wrong-cell” when the original serving cell intends to perform the handover for this UE towards a particular target cell but the UE declares the RLF and reestablishes itself in a third cell.
   b. A corrective action from the original serving cell can be to initiate the measurement reporting procedure that leads to handover towards the target cell a bit later by decreasing the CIO towards the target cell or via initiating the handover towards the cell in which the UE reestablished a bit earlier by increasing the CIO towards the reestablishment cell.

### Successful Handover Report (SHR).

SHR has been discussed in Rel-16 SON system information (SI) and is under standardization in Rel-17. The following outcome was captured at the end of SI in TS 37.816 v16.0.0.

The MRO function in NR could be enhanced to provide a more robust mobility via reporting failure events observed during successful handovers. A solution to this problem is to configure the UE to compile a report associated to a successful handover comprising a set of measurements collected during the handover phase, i.e., measurement at the handover trigger, measurement at the end of handover execution or measurement after handover execution. The UE may be configured with triggering conditions to compile the Successful Handover Report, hence the report would be triggered only if the conditions are met. This limits UE reporting to relevant cases, such as underlying issues detected by radio link monitoring (RLM), or beam failure detection (BFD) detected upon a successful handover event.

The availability of a Successful Handover Report may be indicated by the Handover Complete message (RRCReconfigurationComplete) transmitted from the UE to target NG-RAN node over RRC. The target NG-RAN node may fetch information of a successful handover report via a UE Information Request/Response mechanism. In addition, the target NG-RAN node could then forward the Successful Handover Report to the source NR-RAN node to indicate failures experienced during a successful handover event.

The information contained in the successful handover report may comprise:
RLM related information
RLM related timers, e.g. T310, T312,
Measurements of reference signals used for RLM in terms of RSRP,
RSRQ, signal to interference plus noise ratio (SINR)
RLC retransmission counter
Beam failure detection (BFD) related information
Detection indicators and counters, e.g., Qin and Qout indications,
Measurements of reference signals used in BFD in terms of RSRP, RSRQ, SINR
Handover related information
Measurements of the configured reference signals at the time of successful handover
synchronization signal block (SSB) beam measurements
channel state information-reference signal (CSI-RS) measurements
Handover related timers, e.g., timer T304,
Measurement period indication, i.e., measurements are collected at handover trigger, at the end of handover execution, or just after handover execution

Upon reception of a SHR, the receiving node is able to analyze whether its mobility configuration needs adjustment. Such adjustments may result in changes of mobility configurations, such as changes of RLM configurations or changes of mobility thresholds between the source and the target. In addition, target NG RAN node, in the performed handover, may further optimize the dedicated RACH-beam resources based on the beam measurements reported upon successful handovers.

### SUMMARY

As part of developing embodiments herein, one or more problems was first identified. It is noted that in R2-2105503 it is stated that UE shall not declare master cell group (MCG) RLF upon MCG RACH/Listen Before Talk (LBT) failure detection while MCG T304 is running.

Based on the above agreement, the UE does not declare MCG RLF when the UE's lower layers indicate a RACH issue while the T304 is running at the UE. If the UE completes the handover successfully despite having LBT issues i.e., if the UE completes the HO before T304 expires, then the target cell does not get to know why the UE had a long delay for the UE to access the cell. This could be due to the poor UL coverage or LBT issues, and, therefore, the target cell cannot improve the handover interruption time in an appropriate manner.

An object herein is to provide a mechanism to handle communication of a UE in an efficient manner in the wireless communications network.

According to an aspect the object is achieved, according to embodiments herein, by providing a method performed by a UE for handling communication in a wireless communication network. The UE transmits a SHR to a radio network node, wherein the SHR comprises an indicator indicating whether or not the UE has experienced an LBT failure and/or a random access problem before successfully accessing a target cell in a handover procedure.

According to another aspect the object is achieved, according to embodiments herein, by providing a method performed by a radio network node for handling communication in a wireless communication network. The radio network node receives a SHR from a UE, wherein the SHR comprises an indicator indicating whether or not the UE has experienced an LBT failure and/or a random access problem before successfully accessing a target cell in a handover procedure. The radio network node may then provide the indicator to a network node or a function for handling radio optimization.

According to a further aspect, the object is achieved by providing a UE and a radio network node configured to perform the methods herein, respectively.

Thus, according to yet another aspect the object is achieved, according to embodiments herein, by providing a UE for handling communication in a wireless communication network. The UE is configured to transmit a SHR to a radio network node, wherein the SHR comprises an indicator indicating whether or not the UE has experienced an LBT failure and/or a random access problem before successfully accessing a target cell in a handover procedure.

According to still another aspect the object is achieved, according to embodiments herein, by providing a radio network node for handling communication in a wireless communication network. The radio network node is configured to receive a SHR from a UE, wherein the SHR comprises an indicator indicating whether or not the UE has experienced an LBT failure and/or a random access problem before successfully accessing a target cell in a handover procedure.

It is furthermore provided herein a computer program product comprising instructions, which, when executed on at least one processor, cause the at least one processor to carry out the methods herein, as performed by the UE or the radio network node, respectively. It is additionally provided herein a computer-readable storage medium, having stored thereon a computer program product comprising instructions which, when executed on at least one processor, cause the at least one processor to carry out the methods herein, as performed by the UE or the radio network node, respectively.

Embodiments herein disclose a solution wherein the radio network node or another network node can differentiate whether a latency in the handover of the UE was due to LBT issue(s), or a random access (RA) problem experienced by the UE, or due to the UL coverage issues. For example, if a target node receives an SHR in which the UE indicates that it had LBT issues, then the target node may not need to tune its UL coverage related parameters, whereas if the target node receives a SHR in which the UE indicates that it did not have any LBT issues and the interruption time is too high, then the target node needs to tune its UL coverage related parameters. Thus, by using the indicator in the SHR the communication of a UE may be handled in an efficient manner in the wireless communications network.

### BRIEF DESCRIPTION OF THE DRAWINGS

Embodiments will now be described in more detail in relation to the enclosed drawings, in which:

FIG. 1 shows ramifications of Self-Configuration/Self-Optimization functionality according to prior art;

FIG. 2 shows an overview depicting a wireless communications network according to embodiments herein;

FIG. 3 shows a combined signalling scheme and flowchart depicting embodiments herein;

FIG. 4 shows a flowchart depicting a method performed by a UE according to embodiments herein;

FIG. 5 shows a flowchart depicting a method performed by a radio network node according to embodiments herein;

FIG. 6 shows a block diagram depicting embodiments of a UE according to embodiments herein;

FIG. 7 shows a block diagram depicting embodiments of a radio network node according to embodiments herein;

FIG. 8 schematically illustrates a telecommunication network connected via an intermediate network to a host computer;

FIG. 9 is a generalized block diagram of a host computer communicating via a base station with a user equipment over a partially wireless connection; and

FIGS. 10, 11, 12, and 13 are flowcharts illustrating methods implemented in a communication system including a host computer, a base station, and a user equipment.

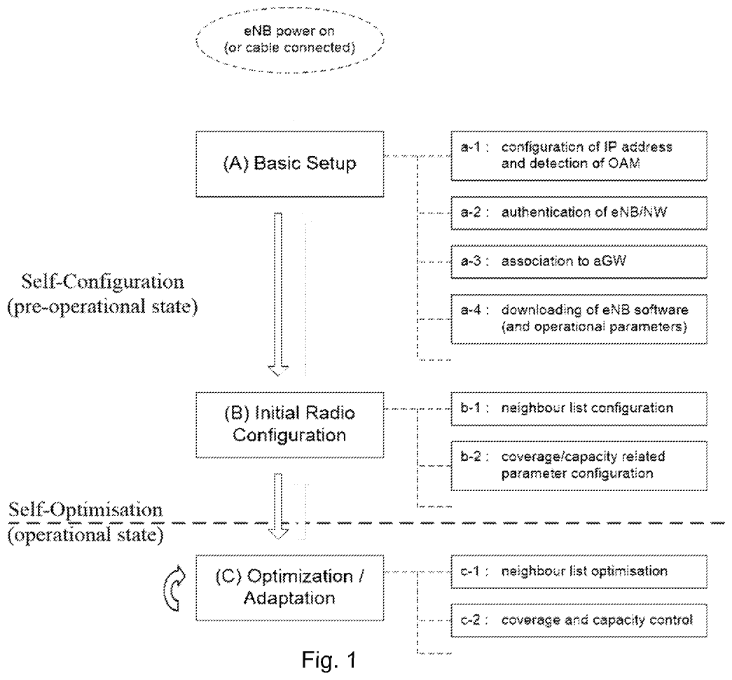

### DETAILED DESCRIPTION

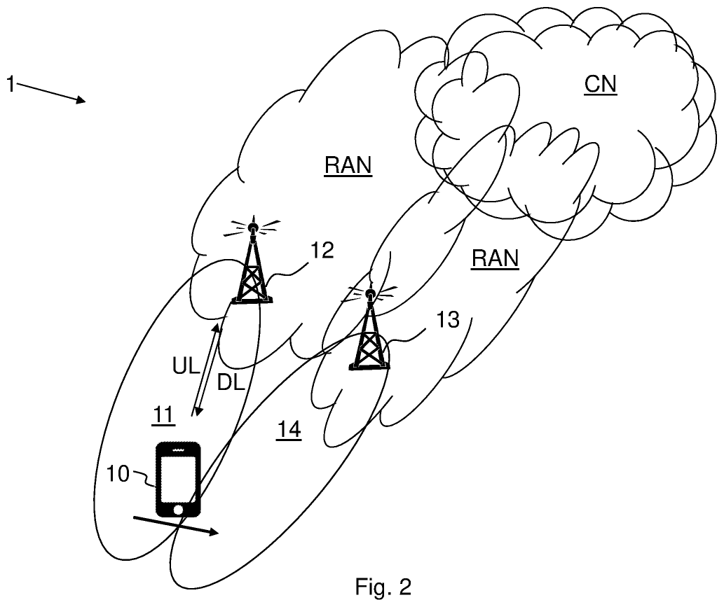

Embodiments herein relate to wireless communications networks in general. FIG. 2 is a schematic overview depicting a wireless communications network 1. The wireless communications network 1 comprises one or more access networks, such as RANs, and one or more CNs. The wireless communications network 1 may use one or a number of different technologies. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the wireless communications network 1, a user equipment (UE) 10 exemplified herein as a wireless device such as a mobile station, a non-access point (non-AP) station (STA), a STA and/or a wireless terminal, is comprised communicating via e.g. one or more Access Networks (AN), e.g. radio access network (RAN), to one or more core networks (CN). It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communications network 1 comprises a first radio network node 12 providing radio coverage over a geographical area, a first service area 11 or first cell, of a first radio access technology (RAT), such as NR, LTE, or similar. The first radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node depending e.g. on the first radio access technology and terminology used. The first radio network node 12 may be referred to as a serving or source radio network node, wherein the service area may be referred to as a serving cell, and the serving network node communicates with the wireless device in form of DL transmissions to the wireless device and UL transmissions from the wireless device. It should be noted that a service area may be denoted as cell, beam, beam group or similar to define an area of radio coverage. The first radio network node may be referred to as a first public land mobile network (PLMN) radio network node, wherein the service area may be referred to as a first PLMN cell.

The wireless communications network 1 comprises a second radio network node 13 providing radio coverage over a geographical area, a second service area 14 or second cell, of a second radio access technology (RAT), such as NR, LTE, or similar. The second radio network node 13 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node depending e.g. on the second radio access technology and terminology used. The second radio network node may be referred to as a second PLMN radio network node, wherein the service area may be referred to as a second PLMN cell.

When operating in unlicensed spectrum, many regions in the world require a UE to sense the medium as free before transmitting. This operation is often referred to as listen before talk (LBT). LBT is essential in the unlicensed spectrum to ensure a fair co-existence with other RATs operating in the same spectrum. In this mechanism, a UE applies a clear channel assessment (CCA) check, also referred to as channel sensing, before any transmission. There are many different flavors of LBT, depending on which radio technology the UE uses and which type of data it wants to transmit at the moment. Common for all flavors is that the sensing is done in a particular channel, corresponding to a defined carrier frequency, and over a predefined bandwidth. For example, in the 5 GHz band, the sensing is done over 20 MHz channels. Many UEs are capable of transmitting, and receiving, over a wide bandwidth including of multiple sub-bands/channels, e.g., LBT sub-band, i.e., the frequency part with bandwidth equals to LBT bandwidth. A UE is only allowed to transmit on the sub-bands where the medium is sensed as free. Such LBT procedure has to be performed by both the radio network node and the UE, whenever they intend to transmit something on the unlicensed spectrum, and that is also applicable to any UL/DL transmission, i.e., both data, layer-1/2/3 control signaling.

More specifically, the LBT procedure implies that the transmitter performs energy detection (ED) over a time period compared to a certain threshold (ED threshold) in order to determine if a channel is idle. In case the channel is determined to be occupied, the transmitter performs a random back-off within a contention window before next CCA attempt. In order to protect the acknowledgment (ACK) transmissions, the transmitter must defer a period after each busy CCA slot prior to resuming back-off. As soon as the transmitter has grasped access to a channel, the transmitter is only allowed to perform transmission up to a maximum time duration, such as the maximum channel occupancy time (MCOT).

For quality of service (QOS) differentiation, a channel access priority based on the service type has been defined. For example, there are four LBT priority classes defined for differentiation of contention window sizes (CWS) and MCOT between services. Therefore, the LBT class selected for a transmission depends on the priority of the data to transmit or on the type of signal to transmit, e.g., if that is a physical random access channel (PRACH), Physical uplink control channel (PUCCH), or RRC signal.

According to embodiments herein the UE 10 is configured, either preconfigured or configured by the radio network node 12, to report, in an SHR, if a successful HO to the second cell is affected by an LBT issue or not, and/or affected by a random access problem or not. The SHR may thus comprise only LBT failure related information or only random access problem related information or both of them. Embodiments thus ensure that radio optimization such as determine mobility related parameters, e.g., trigger conditions of measurement reports, may be performed based on relevant information. This will lead to an efficient use of resources in the wireless communication network.

It is to be noted that embodiments herein are described in connection with NR related examples, but embodiments herein are also applicable in other radio access technologies.

Furthermore, a disclosed scenario herein is when the UE 10 is performing handover and start a timer T304, however, the same methods and solution may also be applied to all those cases when a timer, such as the timer T304, is started upon reception of RRCReconfiguration message including reconfigurationWithSync or upon conditional reconfiguration execution, i.e., when applying a stored RRCReconfiguration message including reconfigurationWithSync. Further, embodiments herein are not limited specifically to the handling of timer T304 but may be applied to any other timer in any other radio access technologies that may have a timer that has the similar conditions of start, stop, and expiry of timer T304.

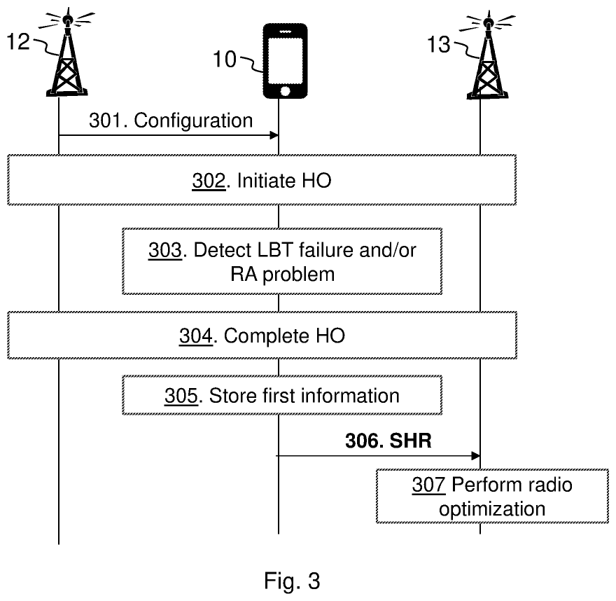

FIG. 3 is a combined signalling scheme and flowchart according to embodiments herein.

Action 301. The first radio network node 12 may transmit configuration data to the UE 10 for configuring the UE to perform methods herein.

Action 302. The UE 10 or the first radio network node 12 initiates a HO of the UE to the second radio network node 13 from the first radio network node 12.

Action 303. The UE 10, during the HO to the second network node 13, may detect at least one of the following:
One or more LBT failures while a handover related timer, such as the T304 timer, is running;
Consistent UL LBT failures in one or more of the UL bandwidth parts (BWP) where PRACH resources are configured; and
Random access problem in MAC layer while a handover related timer (T304) is running, e.g. due to the expiry of ra-ResponseWindow upon msg1 transmission or msgB-ResponseWindow upon msgA transmission, or ra-ContentionResolution Timer upon msg3 transmission.

Action 304. The UE 10 may then successfully complete the handover towards the second radio network node 13 before the handover related timer expires.

Action 305. The UE 10 may then store a first information associated to at least one of the following:
the detected one or more uplink LBT failures experienced while the handover related timer was running;
the detected consistent UL LBT failures in one or more of the UL BWPs configured with PRACH resources; and
the detected random access problem experienced while the handover related timer was running.

Action 306. The UE 10 transmits a SHR to a radio network node, such as the second radio network node 13 or another radio network node, wherein the SHR comprises an indicator indicating whether or not the UE has experienced LBT failure and/or a random access problem before successfully accessing a target cell in a handover procedure.

Action 307. The radio network node, such as the second radio network node 13, receiving the SHR from the UE 10 may then perform radio optimization, such as determine radio parameters, taking the indicator in the SHR into account.

Thus, the network can differentiate whether the latency in the handover was due to the LBT issues experienced by the UE 10 or due to the UL coverage issues. For example, if a source radio network node, such as the first radio network node 12, receives an SHR in which the UE 10 indicates that it had LBT issues, then the source radio network node does not need to tune its UL coverage related parameters, whereas if the source radio network node receives an SHR in which the UE 10 indicates that it did not have any LBT issues and the interruption time is too high, then a target radio network node, such as the second radio network node 13, may need to tune its UL coverage related parameters.

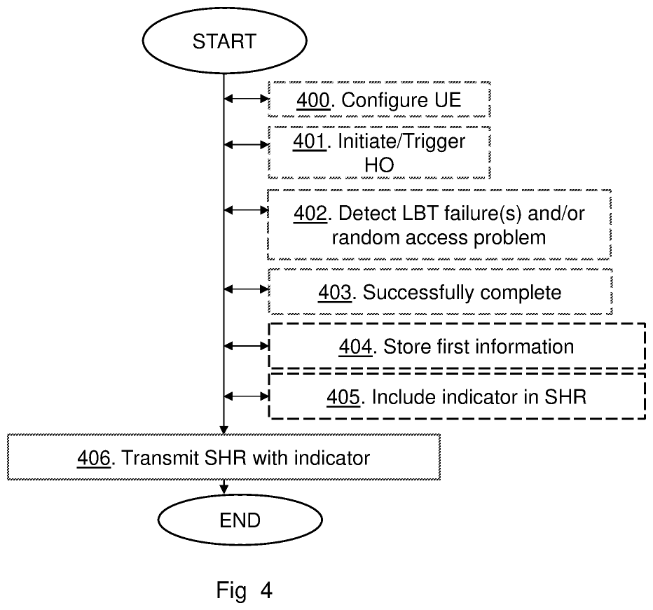

The method actions performed by the UE 10 for handling communication in the wireless communications network according to embodiments will now be described with reference to a flowchart depicted in FIG. 4. The actions do not have to be taken in the order stated below, but may be taken in any suitable order. Dashed boxes indicate optional features.

Action 400. The UE 10 may be configured by a radio network node, such as the first radio network node 12, to perform the method herein.

Action 401. The UE 10 may initiate or trigger a HO of the UE 10 to the second radio network node 13 from the first radio network node 12.

Action 402. The UE 10, during the HO procedure from the first radio network node 12 to the second network node 13, may detect one or more LBT failures and/or a random access problem. For example, the UE 10 may detect at least one of the following:
One or more LBT failures while a handover related timer, such as the T304 timer, is running;
Consistent UL LBT failures in one or more of the UL BWP) where PRACH resources are configured; and
Random access problem in MAC layer while a handover related timer (T304) is running, e.g. due to the expiry of ra-ResponseWindow upon msg1 transmission or msgB-ResponseWindow upon msgA transmission, or ra-ContentionResolution Timer upon msg3 transmission.

Action 403. The UE 10 may then successfully complete the handover towards the second radio network node 13 before the handover related timer expires.

Action 404. The UE 10 may, upon successfully completing the handover procedure before the handover related timer expires, then store the first information indicating whether or not the UE has experienced LBT failure and/or a random access problem. For example, the UE 10 may store first information associated with the one or more LBT failures and/or the random access problem.

For example, the UE 10 may store the first information indicating at least one of the following:
the detected one or more uplink LBT failures experienced while the handover related timer was running;
the detected consistent UL LBT failures in one or more of the UL BWPs configured with PRACH resources; and
the detected random access problem experienced while the handover related timer was running.

Action 405. The UE 10 may include the indicator in the SHR report, indicating that the UE has experienced one or more UL, LBT failures while a timer T304 was running and/or the UE has experienced random access problem while the timer T304 was running, and wherein said one or more LBT failures were experienced for the transmission of random access (RA)-related messages, i.e. LBT failures experienced while attempting to transmit the PRACH msg1/msgA, or the msg3.

Action 406. The UE 10 then transmits the SHR to the radio network node, such as the second radio network node 13 or the other radio network node, wherein the SHR comprises the indicator indicating whether or not the UE 10 has experienced an LBT failure and/or the random access problem before successfully accessing the target cell in the handover procedure. The UE 10 may, for example, transmit the first information, being the indicator, to the radio network node.

In case the UE is configured with Dual Active Protocol Stack (DAPS), the UE 10 may include a separate indication indicating that the UE 10 experienced one or more LBT failures while transmitting physical uplink shared channel (PUSCH) transmissions to the source cell after starting the timer T304, or it may avoid including, in the SHR, this information associated to PUSCH transmissions to the source cell after starting timer T304. The indicator may be a real value, an index value, or similar.

In some embodiments, the UE 10 may include, in the SHR, the indicator only when the UE 10 has experienced a consistent UL LBT failure, e.g. a number of UL LBT failures greater than a certain threshold, in one or more of the UL BWPs where PRACH resources are configured.

In some embodiments, the UE 10 may include, in the SHR, the indicator indicating number of times the UE has received the LBT failure while trying to perform the random access procedure, i.e. transmissions of PRACH msg1/msgA or msg3. In some embodiments, rather than the number of LBT failures, it is indicated with the indicator such as a percentage of LBT failures with respect to an overall amount of attempted PRACH transmissions or msg3 transmissions.

In some embodiments, the UE 10 may include, in the SHR, a duration indication indicating a duration for which the UE experienced the LBT issues while performing the handover procedure.

The UE 10 may further indicate a bandwidth, such as BWP ID(s) or the PRACH configuration(s) associated to the BWP(s), in which the UE 10 detected LBT failures while performing random access.

The UE 10 may include, in the SHR, for each RA attempt performed while the timer T304 is running, the indicator of whether an LBT-failure was experienced when attempting to transmit the msg1/msgA or the msg3. The indicator can be conveyed by including, in the SHR, an RA-InformationCommon information element (IE), which includes a perRAInfoList IE, i.e., information associated to each RA attempt for this random access procedure while the timer T304 is running. The information may be information associated to each RA attempt, e.g., whether the UE experienced contention or not and whether the DL SSB/CSI RSRP associated to the RA resource is above a threshold or not, for this random access procedure while timer T304 is running.

The indicator associated to LBT failures may be included in the SHR only if the amount of LBT failures is above a certain threshold, e.g., only if the UE experienced at least one consistent UL LBT failure in one UL BWP. The indicator may only be included if the value of the timer T304 at HO completion is above a certain threshold, thus, indicating that the HO is delayed. In some embodiments, the indicator may only be included in the SHR if the value of the timer T304 at HO completion is above a certain threshold, and the amount of LBT failures is above a certain threshold. The certain threshold may be configurable.

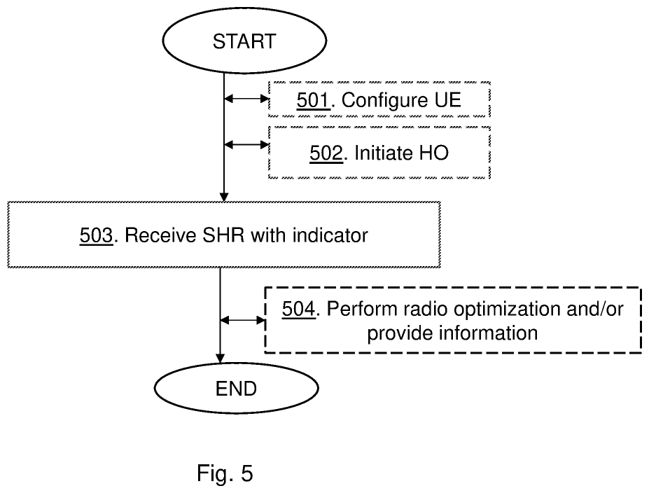

The method actions performed by a radio network node, such as the first or the second radio network node 13, for handling communication in the wireless communications network according to embodiments will now be described with reference to a flowchart depicted in FIG. 5. The actions do not have to be taken in the order stated below, but may be taken in any suitable order. Dashed boxes indicate optional features. Action 501. The radio network node, such as the first radio network node 12, may transmit configuration data to the UE 10 for configuring the UE 10 to perform methods herein.

Action 502. The radio network node may initiate a HO of the UE to the second radio network node 13 from the first radio network node 12.

Action 503. The radio network node, such as the first radio network node 12 or the second radio network node 13, receives the SHR from the UE 10, wherein the SHR comprises the indicator indicating whether or not the UE 10 has experienced the LBT failure and/or the random access problem before successfully accessing the target cell in the handover procedure. The indicator may indicate at least one of the following:
One or more LBT failures while the handover related timer, such as the T304 timer, is running;
Consistent UL LBT failures in one or more of the UL BWP where PRACH resources are configured; and
Random access problem in MAC layer while the handover related timer (T304) is running, e.g. due to the expiry of ra-ResponseWindow upon msg1 transmission or msgB-ResponseWindow upon msgA transmission, or ra-ContentionResolution Timer upon msg3 transmission.

Action 504. The radio network node, such as the second radio network node 13, receiving the SHR from the UE 10 may then perform radio optimization, such as determine radio parameters, taking the indicator in the SHR into account. The radio network node may, alternatively or additionally, provide or forward information such as the indicator to another radio network node for performing the radio optimization based on the indicator. Thus, the radio network node performing the radio optimization may differentiate whether the latency in the handover was due to the LBT issues experienced by the UE or due to the UL coverage issues.

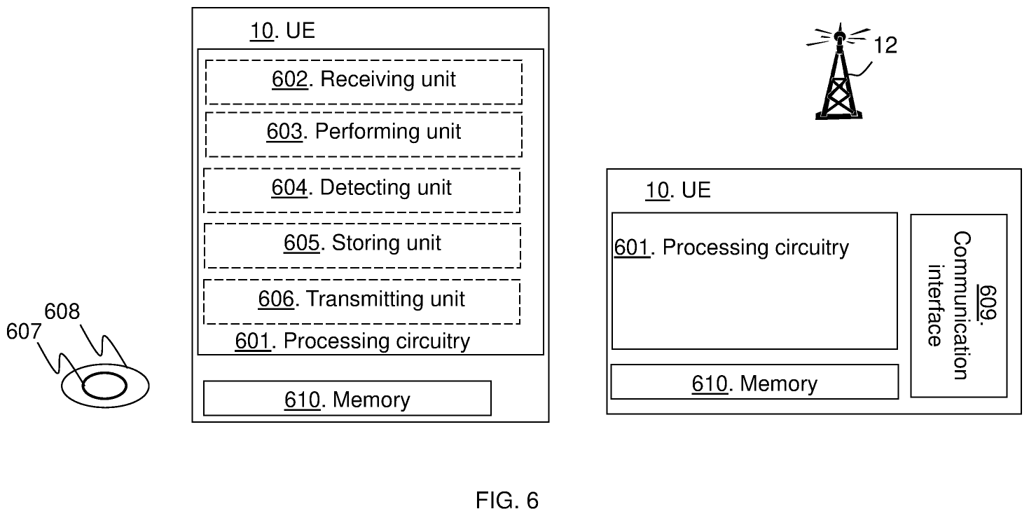

FIG. 6 is a block diagram depicting a wireless communications network 1 comprising embodiments of the UE 10 for handling communication.

The UE 10 may comprise processing circuitry 601, e.g., one or more processors, configured to perform the methods herein.

The UE 10 may comprise a receiving unit 602, e.g., a receiver or a transceiver. The UE 10, the processing circuitry 601 and/or the receiving unit 602 may be configured to receive configuration data from a radio network node such as the first radio network node 12 to be configured to perform the methods herein.

The UE 10 may comprise a performing unit 603, e.g., a measuring unit. The UE 10, the processing circuitry 601 and/or the performing unit 603 may be configured to initiate or trigger a HO of the UE 10 to the second radio network node 13 from the first radio network node 12. The UE 10, the processing circuitry 601 and/or the performing unit 603 may be configured to successfully complete the handover towards the second radio network node 13 before the handover related timer expires.

The UE 10 may comprise a detecting unit 604. The UE 10, the processing circuitry 601 and/or the detecting unit 604 may be configured to detect, during the HO procedure from the first radio network node 12 to the second network node 13, one or more LBT failures and/or a random access problem. For example, detect at least one of the following:
One or more LBT failures while a handover related timer, such as the T304 timer, is running;
Consistent UL LBT failures in one or more of the UL bandwidth parts (BWP) where PRACH resources are configured; and
Random access problem in MAC layer while a handover related timer (T304) is running, e.g. due to the expiry of ra-ResponseWindow upon msg1 transmission or msgB-ResponseWindow upon msgA transmission, or ra-ContentionResolution Timer upon msg3 transmission.

The UE 10 may comprise a storing unit 605. The UE 10, the processing circuitry 601 and/or the storing unit 605 may be configured to, upon successfully completing the handover procedure before the handover related timer expires, store the first information indicating whether or not the UE has experienced LBT failure and/or a random access problem. The first information may thus be associated with the one or more LBT failures and/or the random access problem. For example, store the first information indicating at least one of the following:
the detected one or more uplink LBT failures experienced while the handover related timer was running;
the detected consistent UL LBT failures in one or more of the UL BWPs configured with PRACH resources; and
the detected random access problem experienced while the handover related timer was running.

The UE 10 may comprise a transmitting unit 606, e.g. a transmitter or a transceiver. The UE 10, the processing circuitry 601 and/or the transmitting unit 606 is configured to transmit the SHR to the radio network node, such as the second radio network node 13 or the other radio network node, wherein the SHR comprises the indicator indicating whether or not the UE has experienced an LBT failure and/or a random access problem before successfully accessing the target cell in the handover procedure. The UE 10, the processing circuitry 601 and/or the transmitting unit 606 is configured to transmit, for example, the first information, being the indicator, to the radio network node. Thus, the UE 10, the processing circuitry 601 and/or the transmitting unit 606 may be configured to include the indicator in the SHR report, indicating that the UE 10 has experienced one or more UL LBT failures while timer T304 was running and/or the UE 10 has experienced random access problem while timer T304 was running, and wherein said one or more LBT failures were experienced for the transmission of RA-related messages, i.e. LBT failures experienced while attempting to transmit the PRACH msg1/msgA, or the msg3. In case the UE is configured with Dual Active Protocol Stack DAPS, the UE 10, the processing circuitry 601 and/or the transmitting unit 606 may be configured to include a separate indication indicating that the UE 10 experienced one or more LBT failures while transmitting PUSCH transmissions to the source cell after starting the timer T304, or it may avoid including, in the SHR, this information associated to PUSCH transmissions to the source cell after starting timer T304. The indicator may be a real value, an index value or similar. The UE 10, the processing circuitry 601 and/or the transmitting unit 606 may be configured to include, in the SHR, the indicator only when the UE 10 has experienced a consistent UL LBT failure, i.e. a number of UL LBT failures greater than a certain threshold, in one or more of the UL BWPs where PRACH resources are configured.

The UE 10, the processing circuitry 601 and/or the transmitting unit 606 may be configured to include, in the SHR, the indicator indicating number of times the UE has received the LBT failure while trying to perform the random access procedure, i.e. transmissions of PRACH msg1/msgA or msg3. In some embodiments, rather than the number of LBT failures it is indicated with the indicator a percentage of LBT failures with respect to an overall amount of attempted PRACH transmissions or msg3 transmissions. The UE 10, the processing circuitry 601 and/or the transmitting unit 606 may be configured to include, in the SHR, the duration indication indicating the duration for which the UE experienced the LBT issues while performing the handover procedure.

The UE 10, the processing circuitry 601 and/or the transmitting unit 606 may be configured to indicate the bandwidth such as BWP ID(s) or the PRACH configuration(s) associated to the BWP(s) in which the UE 10 detected LBT failures while performing random access. The UE 10, the processing circuitry 601 and/or the transmitting unit 606 may be configured to include, in the SHR, for each RA attempt performed while the timer T304 is running, the indicator of whether an LBT-failure was experienced when attempting to transmit the msg1/msgA or the msg3. The indicator can be conveyed by including, in the SHR, an RA-InformationCommon information element (IE), which includes a perRAInfoList IE, i.e., information associated to each RA attempt for this random access procedure while the timer T304 is running. The indicator associated to LBT failures may be included in the SHR only if the amount of LBT failures is above a certain threshold, e.g., only if the UE experienced at least one consistent UL LBT failure in one UL BWP. The indicator may only be included if the value of the timer T304 at HO completion is above a certain threshold. In some embodiments, the indicator may only be included in the SHR if the value of the timer T304 at HO completion is above a certain threshold, and the amount of LBT failures is above a certain threshold.

The UE may comprise a memory 610. The memory 610 may comprise one or more units to be used to store data on, such as data packets, SHR, indicators, one or more conditions, mobility events, measurements, events and applications to perform the methods disclosed herein when being executed, and similar. Furthermore, the UE 10 may comprise a communication interface 609 such as comprising a transmitter, a receiver, a transceiver and/or one or more antennas.

The methods according to the embodiments described herein for the UE 10 are respectively implemented by means of, e.g., a computer program product 607 or a computer program, comprising instructions, i.e., software code portions, which, when executed on at least one processor, cause the at least one processor to carry out the actions described herein, as performed by the UE 10. The computer program product 607 may be stored on a computer-readable storage medium 608, e.g. a disc, a universal serial bus (USB) stick or similar. The computer-readable storage medium 608, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium. Thus, embodiments herein may disclose a UE for handling communication in a wireless communications network, wherein the UE comprises processing circuitry and a memory, said memory comprising instructions executable by said processing circuitry whereby said UE is operative to perform any of the methods herein.

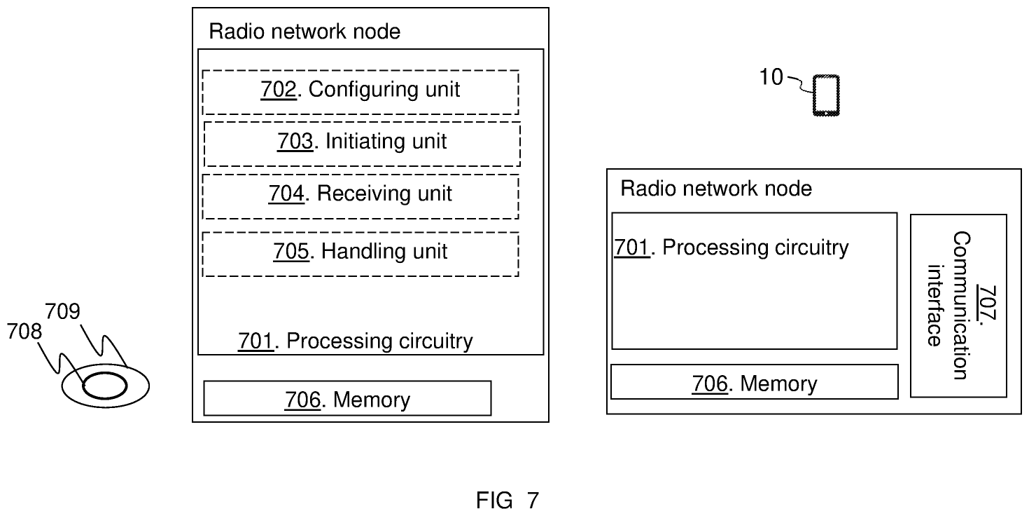

FIG. 7 is a block diagram depicting the radio network node, such as the first radio network node 12 or the second radio network node 13, for handling communication in the wireless communications network 1 according to embodiments herein.

The radio network node may comprise processing circuitry 701, e.g. one or more processors, configured to perform the methods herein.

The radio network node may comprise a configuring unit 702, e.g. a transmitter or a transceiver. The radio network node, the processing circuitry 701 and/or the configuring unit 702 may be configured, e.g., when being the first radio network node 12, to configure the UE by transmitting configuration data to the UE 10 for configuring the UE 10 to perform methods herein.

The radio network node may comprise an initiating unit 703. The radio network node, the processing circuitry 701 and/or the initiating unit 703 may be configured, e.g. when being the first radio network node 12, to initiate the HO of the UE to the second radio network node 13 from the first radio network node 12.

The radio network node 12 may comprise a receiving unit 704, e.g. a transmitter or a transceiver. The radio network node 12, the processing circuitry 701 and/or the receiving unit 704 is configured to, e.g. when being the second radio network node 13, receive, from the UE 10, the SHR, wherein the SHR comprises the indicator indicating whether or not the UE has experienced LBT failure and/or a random access problem before successfully accessing a target cell in a handover procedure. The indicator may indicate at least one of the following:
One or more LBT failures while a handover related timer, such as the T304 timer, is running;
Consistent UL LBT failures in one or more of the UL bandwidth parts (BWP) where PRACH resources are configured; and
Random access problem in MAC layer while a handover related timer (T304) is running, e.g. due to the expiry of ra-ResponseWindow upon msg1 transmission or msgB-ResponseWindow upon msgA transmission, or ra-ContentionResolution Timer upon msg3 transmission.

The radio network node may comprise a handling unit 705. The radio network node, the processing circuitry 701 and/or the handling unit 705 may be configured to perform radio optimization, such as determine radio parameters, taking the indicator in the SHR into account. Alternatively or additionally, the radio network node, the processing circuitry 701 and/or the handling unit 705 may be configured to provide or forward information such as the indicator to another radio network node for performing the radio optimization based on the indicator.

The radio network node may comprise a memory 706. The memory 706 comprises one or more units to be used to store data on, such as indicators, SHRs, mobility events, configurations, events and applications to perform the methods disclosed herein when being executed, and similar. Furthermore, the radio network node may comprise a communication interface 707 such as comprising a transmitter, a receiver, a transceiver and/or one or more antennas. The methods according to the embodiments described herein for the radio network node are respectively implemented by means of e.g. a computer program product 708 or a computer program, comprising instructions, i.e., software code portions, which, when executed on at least one processor, cause the at least one processor to carry out the actions described herein, as performed by the radio network node. The computer program product 708 may be stored on a computer-readable storage medium 709, e.g. a disc, a universal serial bus (USB) stick or similar. The computer-readable storage medium 709, having stored thereon the computer program product, may comprise the instructions which, when executed on at least one processor, cause the at least one processor to carry out the actions described herein, as performed by the radio network node. In some embodiments, the computer-readable storage medium may be a transitory or a non-transitory computer-readable storage medium. Thus, embodiments herein may disclose a radio network node for handling communication in a wireless communications network, wherein the radio network node comprises processing circuitry and a memory, said memory comprising instructions executable by said processing circuitry whereby said radio network node is operative to perform any of the methods herein.

In some embodiments, a more general term “radio network node” is used, and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, gNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments, the non-limiting term wireless device or user equipment (UE) is used, and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles, etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Embodiments herein relate to:

### Embodiment 1

A method performed by a UE for handling communication in a wireless communication network, the method comprising
transmitting a SHR to a radio network node, wherein the SHR comprises an indicator indicating whether or not the UE has experienced LBT failure and/or a random access problem before successfully accessing a target cell in a handover procedure.

### Embodiment 2

The method according to embodiment 1, further comprising
detecting, during the HO procedure from a first radio network node to a second network node, one or more LBT failures and/or a random access problem.

### Embodiment 3

The method according to any of the embodiments 1-2, further comprising, upon successfully completing the handover procedure before a handover related timer expires, storing first information indicating whether or not the UE has experienced LBT failure and/or a random access problem, and the indicator transmitted indicated the first information.

### Embodiment 4

The method according to embodiment 3, wherein the first information includes at least one of the following:
the detected one or more uplink LBT failures experienced while the handover related timer was running;
the detected consistent UL LBT failures in one or more of the UL BWPs configured with PRACH resources; and
the detected random access problem experienced while the handover related timer was running.

### Embodiment 5

The method according to any of the embodiments 1-4, comprising
including the indicator in the SHR report, indicating that the UE has experienced one or more UL LBT failures while timer T304 was running or the UE has experienced random access problem while timer T304 was running, and wherein said one or more LBT failures were experienced for the transmission of RA-related messages Embodiment 6:

The method according to any of the embodiments 1-5, wherein the indicator is only transmitted in the SHR when the UE has experienced a number of UL LBT failures greater than a certain threshold, in one or more of the UL BWPs where PRACH resources where configured.

### Embodiment 7

The method according to any of the embodiments 1-6, wherein the indicator indicates number of times the UE has received the LBT failure while trying to perform the random access procedure.

### Embodiment 8

The method according to any of the embodiments 1-7, wherein the indicator indicates a percentage of LBT failures with respect to an overall amount of attempted PRACH transmissions or msg3 transmissions.

### Embodiment 9

The method according to any of the embodiments 1-8, wherein the SHR further comprises a duration indication indicating a duration for which the UE experienced the LBT issues while performing the handover procedure.

### Embodiment 10

A method performed by a radio network node for handling communication in a wireless communication network, the method comprising
receiving a SHR from a UE, wherein the SHR comprises an indicator indicating whether or not the UE has experienced LBT failure and/or a random access problem before successfully accessing a target cell in a handover procedure.

### Embodiment 11

The method according to embodiment 10, wherein the indicator indicates at least one of the following:
One or more LBT failures while a handover related timer is running;
Consistent UL LBT failures in one or more of the UL BWP where PRACH resources are configured; and
Random access problem in MAC layer while a handover related timer is running.

### Embodiment 12

The method according to any of the embodiments 10-11, further comprising
performing radio optimization taking the indicator in the SHR into account.

### Embodiment 13

The method according to any of the embodiments 10-11, further comprising
providing information to another radio network node for performing the radio optimization based on the indication.

### Embodiment 14

A UE for handling communication in a wireless communication network, wherein the UE is configured to
transmit a SHR to a radio network node, wherein the SHR comprises an indicator indicating whether or not the UE has experienced LBT failure and/or a random access problem before successfully accessing a target cell in a handover procedure.

### Embodiment 15

A radio network node for handling communication in a wireless communication network, wherein the radio network node is configured to
receive a SHR from a UE, wherein the SHR comprises an indicator indicating whether or not the UE has experienced LBT failure and/or a random access problem before successfully accessing a target cell in a handover procedure.

### Embodiment 16

A UE for handling communication in a wireless communication network, wherein the UE comprises processing circuitry and a memory, said memory comprising instructions executable by said processing circuitry whereby said UE is operative to
transmit a SHR to a radio network node, wherein the SHR comprises an indicator indicating whether or not the UE has experienced LBT failure and/or a random access problem before successfully accessing a target cell in a handover procedure.

### Embodiment 17

A radio network node for handling communication in a wireless communication network, wherein the radio network node comprises processing circuitry and a memory, said memory comprising instructions executable by said processing circuitry whereby said radio network node is operative to
receive a SHR from a UE, wherein the SHR comprises an indicator indicating whether or not the UE has experienced LBT failure and/or a random access problem before successfully accessing a target cell in a handover procedure.

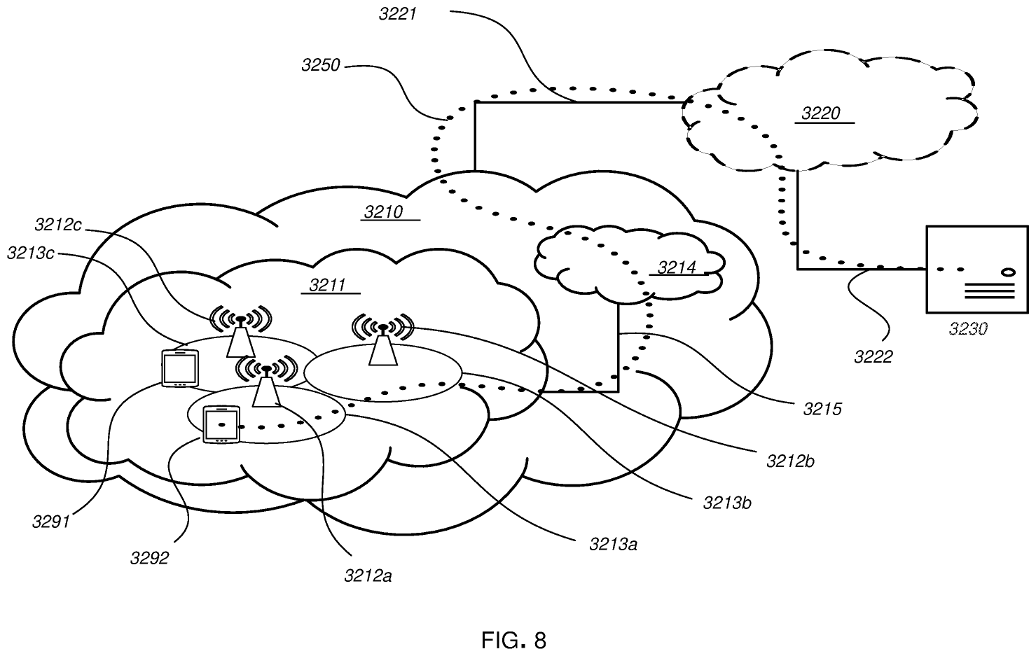

With reference to FIG. 8, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10 and relay UE 13, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 8 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

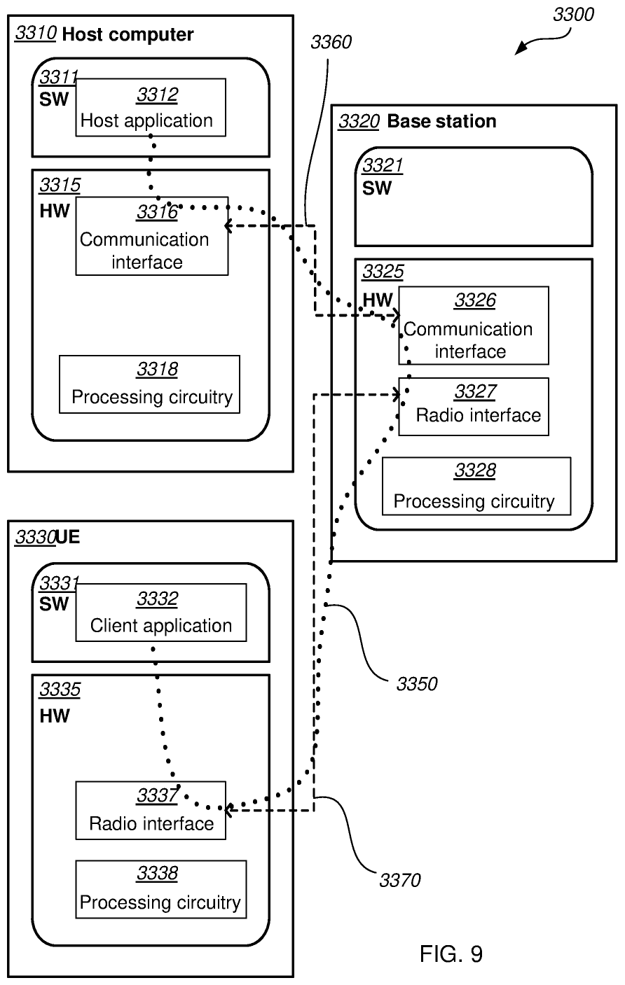

Example implementations, in accordance with an embodiment, of the UE, base station and host computer discussed in the preceding paragraphs will now be described with reference to FIG. 9. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 9) served by the base station 3320. The communication interface 3326 may be configured to facilitate a connection 3360 to the host computer 3310. The connection 3360 may be direct or it may pass through a core network (not shown in FIG. 9) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 9 may be identical to the host computer 3230, one of the base stations 3212a, 3212b, 3212c and one of the UEs 3291, 3292 of FIG. 8, respectively. This is to say, the inner workings of these entities may be as shown in FIG. 9 and independently, the surrounding network topology may be that of FIG. 8.

In FIG. 9, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since radio optimization may be performed more accurately and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

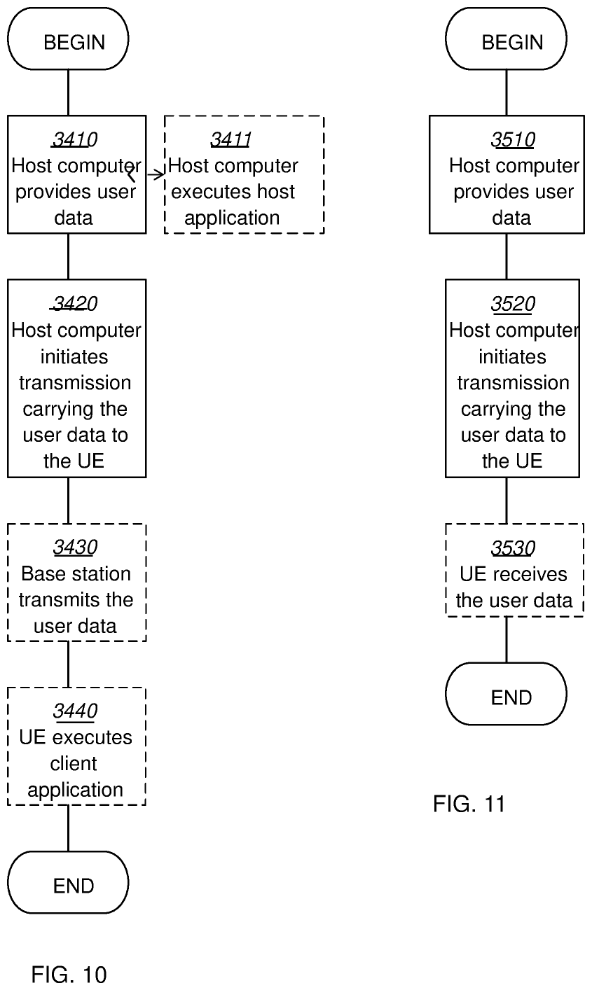

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

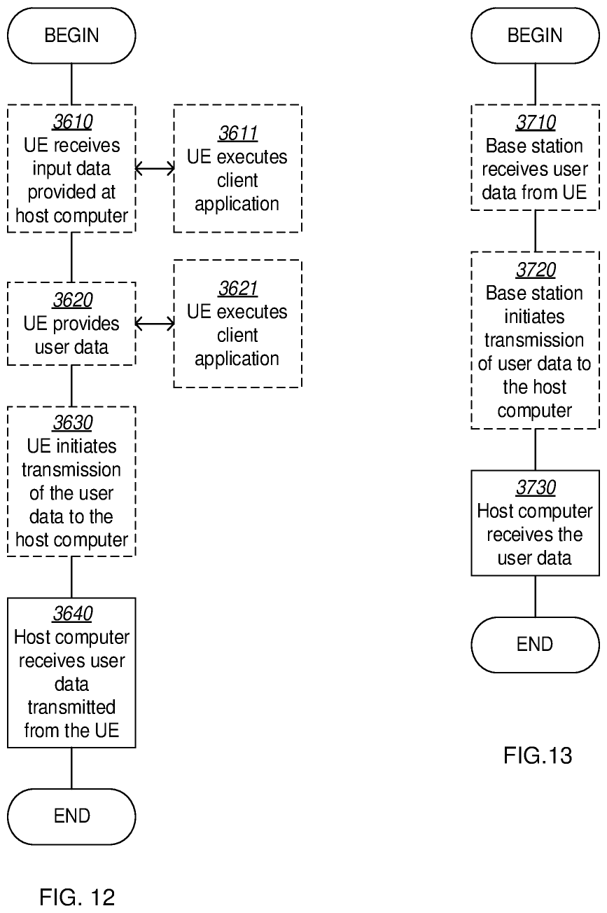

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1.-28. (canceled)

29. A method performed by a user equipment (UE) for handling communication in a wireless communication network, the method comprising
transmitting a successful handover report (SHR) to a radio network node, wherein the SHR comprises an indicator indicating whether or not the UE has experienced a listen before talk (LBT) failure and/or a random access problem before successfully accessing a target cell in a handover (HO) procedure.

30. The method according to claim 29, further comprising detecting, during the HO procedure from a first radio network node to a second network node, one or more LBT failures and/or a random access problem.

31. The method according to claim 29, further comprising, upon successfully completing the handover procedure before a handover related timer expires, storing a first information indicating whether or not the UE has experienced LBT failure and/or a random access problem, wherein the indicator comprised in the transmitted SHR indicates the first information.

32. The method according to the claim 31, wherein the first information includes at least one of the following:
one or more uplink LBT failures experienced while the handover related timer was running;
consistent uplink (UL) LBT failures detected in one or more UL bandwidth parts (BWP) configured with physical random access channel (PRACH) resources; and
a random access problem experienced while the handover related timer was running.

33. The method according to claim 29, further comprising including the indicator in the SHR, indicating that the UE has experienced one or more uplink (UL) LBT failures while a timer T304 was running and/or that the UE has experienced a random access problem while the timer T304 was running, and wherein said one or more uplink LBT failures were experienced for transmission of random access (RA)-related messages.

34. The method according to claim 29, wherein the indicator is only included in the SHR when the UE has experienced a number of uplink (UL) LBT failures greater than a certain threshold, in one or more UL bandwidth parts (BWP) where physical random access channel (PRACH) resources are configured.

35. The method according to claim 29, wherein the indicator indicates a number of times the UE has received the LBT failure while trying to perform a random access procedure.

36. The method according to claim 29, wherein the indicator indicates a percentage of LBT failures with respect to an overall amount of attempted physical random access channel (PRACH) transmissions or msg3 transmissions.

37. The method according to claim 29, wherein the SHR further comprises a duration indication indicating a duration for which the UE experienced LBT issues while performing the handover procedure.

38. A method performed by a radio network node for handling communication in a wireless communication network, the method comprising:
receiving a successful handover report (SHR) from a UE, wherein the SHR comprises an indicator indicating whether or not the UE has experienced a listen before talk (LBT) failure and/or a random access problem before successfully accessing a target cell in a handover procedure.

39. The method according to claim 38, wherein the indicator indicates at least one of the following:
one or more LBT failures while a handover related timer is running;
consistent uplink (UL) LBT failures in one or more UL bandwidth parts (BWP) where physical random access channel (PRACH) resources are configured; and
a random access problem in a medium access control (MAC) layer while a handover related timer is running.

40. The method according to claim 38, further comprising performing radio optimization taking the indicator in the SHR into account.

41. The method according to claim 38, further comprising providing information to another radio network node for performing radio optimization based on the indicator.

42. A user equipment (UE) for handling communication in a wireless communication network, wherein the UE comprises:
processing circuitry configured to transmit a successful handover report (SHR) to a radio network node, wherein the SHR comprises an indicator indicating whether or not the UE has experienced a listen before talk (LBT) failure and/or a random access problem before successfully accessing a target cell in a handover (HO) procedure.

43. The UE according to claim 42, wherein the processing circuitry is further configured to detect, during the HO procedure from a first radio network node to a second network node, one or more LBT failures and/or a random access problem.

44. The UE according to claim 42, wherein the processing circuitry is further configured to, upon successfully completing the handover procedure before a handover related timer expires, store a first information indicating whether or not the UE has experienced LBT failure and/or a random access problem, wherein the indicator comprised in the SHR indicates the first information.

45. The UE according to the claim 44, wherein the first information includes at least one of the following:
one or more uplink LBT failures experienced while the handover related timer was running;
consistent uplink (UL) LBT failures detected in one or more UL bandwidth parts (BWP) configured with physical random access channel (PRACH) resources; and
a random access problem experienced while the handover related timer was running.

46. The UE according to claim 42, wherein the processing circuitry is further configured to include the indicator in the SHR, indicating that the UE has experienced one or more uplink (UL) LBT failures while a timer T304 was running and/or that the UE has experienced a random access problem while the timer T304 was running, and wherein said one or more uplink LBT failures were experienced for transmission of random access (RA)-related messages.

47. The UE according to claim 42, wherein the indicator is only included in the SHR when the UE has experienced a number of uplink (UL) LBT failures greater than a certain threshold, in one or more UL bandwidth parts (BWP) where physical random access channel (PRACH) resources are configured.

48. The UE according to claim 42, wherein the indicator indicates a number of times the UE has received the LBT failure while trying to perform a random access procedure.

49. The UE according to claim 42, wherein the indicator indicates a percentage of LBT failures with respect to an overall amount of attempted physical random access channel (PRACH) transmissions or msg3 transmissions.

50. The UE according to claim 42, wherein the SHR further comprises a duration indication indicating a duration for which the UE experienced LBT issues while performing the handover procedure.

51. A radio network node for handling communication in a wireless communication network, wherein the radio network node comprises:
processing circuitry configured to receive a successful handover report (SHR) from a UE, wherein the SHR comprises an indicator indicating whether or not the UE has experienced a listen before talk (LBT) failure and/or a random access problem before successfully accessing a target cell in a handover procedure.

52. The radio network node according to claim 51, wherein the indicator indicates at least one of the following:
one or more LBT failures while a handover related timer is running;
consistent uplink (UL) LBT failures in one or more UL bandwidth parts (BWP) where physical random access channel (PRACH) resources are configured; and
a random access problem in a medium access control (MAC) layer while a handover related timer is running.

53. The radio network node according to claim 51, wherein the processing circuitry is further configured to perform radio optimization taking the indicator in the SHR into account.

54. The radio network node according to claim 51, wherein the processing circuitry is further configured to provide information to another radio network node for performing radio optimization based on the indicator.
